(19) United States
(12) Patent Application Publication
(10) Pub. No.: US 2011/0176904 A1
(43) Pub. Date: Jul. 21, 2011

(54) Method of transportation for wind turbine tower

(76) Inventor: Henrik Stiesdal, Odense C (DK)

(21) Appl. No.: 13/007,719

(22) Filed: Jan. 17, 2011

(30) Foreign Application Priority Data
Jan. 18, 2010 (EP) 10000418.3

(51) Int. Cl. B60P 7/06

(52) U.S. Cl. 414/800; 410/47

(57) ABSTRACT

A method and an arrangement for transporting a wind turbine tower are provided. A longitudinal axis of a tower segment is substantially aligned horizontally during the transportation. The tower segment is deformed in a cross section during the transportation by a force which is applied to a wall of the tower segment.

### CROSS REFERENCE TO RELATED APPLICATIONS

This application claims priority of European Patent Office Application No. 10000418.3 EP filed Jan. 18, 2010, which is incorporated by reference herein in its entirety.

### FIELD OF INVENTION

The present invention relates to a method of transportation for a wind turbine tower.

### BACKGROUND OF INVENTION

Towers for wind turbines are manufactured and delivered in segments. Those segments are made out of steel plates welded together and have a typically cylindrical or conical shape. At the upper and the lower end of the tower segments are means for fastening like e.g. flanges to join the tower segments together or fasten the lowest tower segment to the foundation. Those flanges are welded to the tower segment before shipping. At the erection site of the wind turbine these tower segments are mounted together or to the foundation by bolt connections.

As the tower segments are stored and transported in a horizontal position, the flanges also avoid unintentional deformation of the tower segment.

For onshore transport the tower segments are mounted on a lorry, which is specially adapted to the transport of those tower segments. The overall height of the transport equals the diameter of the tower segment plus a clearance between the lowest point of the tower segment and the street depending on the mounting on the lorry.

For the on-shore transport by lorry there are limitations in the maximum height of the transport in certain areas, which must not be exceeded, like e.g. bridges or tunnels. One example here is the Elbe Tunnel under the river Elbe in Hamburg, Germany, which allows a maximum height of 4.2 m.

With a given maximum height of the transport the maximum diameter of the tower segments is limited. Bigger diameters can not be transported on-shore on a lorry without extensive planning and time consuming detours, and are therefore not used for the realization of installations.

### SUMMARY OF INVENTION

An object of this invention is to provide an improved method of transportation of a tower segment to overcome the limitation of on-shore transportation.

This object is achieved by a method and an arrangement as claimed in the independent claims. Preferred configurations are object of the dependent claims.

A segment of wind turbine towers, where the longitudinal axis of the segment is aligned horizontally during the transport is deformed in its cross section during the transport by a force, which is applied to the wall of the tower segment.

For the transport of a tower segment with a diameter bigger then the maximum height of the transport minus the clearance between the tower segment and the street, the tower segment is elastically deformed during the transport.

In a preferred configuration the flange is not attached to the tower segment. Thus the tower segment is deformed in its cross section in a horizontally longitudinal shape by the applied force.

Preferably the deformation is in an elastic area of the segment. Thus the segment is enabled to return in its original shape when the force is not applied any longer. If the force exceeds a certain limit the deformation of the segment will reach a so called “plastic area”, where the deformation of the tower segment stays permanently.

Preferably the deformation stays in the elastic area for the tower segment to recover its original shape after decreasing the force of deformation.

Preferably the wall of the tower segment shows a predefined flexibility, thus the applied gravitational force is used to deform the cross section of the segment.

Preferably the force for deformation is brought from inside the segment to its wall.

Preferably deforming means are used to apply the force. They are arranged in a way that the force is applied in horizontal and/or vertical direction to the cross section of the segment.

Preferably the applied force pushes from outward to the wall. Thus the deforming means are detachably fixed to the outer side of the wall.

Preferably the deforming means act on the wall from outside the perimeter from different angles.

In a preferred embodiment the deforming means are active deforming means, thus the force is actively applied to the walls. For example a press or a ram may be used, which are driven e.g. hydraulically, pneumatically, mechanically or electrically.

Preferably the force for deformation is only applied in the area of one end of the segment, to apply a higher deformation to one end of the segment then to the other.

In another embodiment the force for deformation is applied in more then one area along the length of a tower segment in its vertical orientation, to apply deformation along the length of the tower.

It is possible to deform the tower segment elastically just before or at the beginning of the transport and keep it in the elastically deformed shape for the whole transport.

It is also possible to transport the tower segment mainly in the un-deformed shape and just apply the elastic deformation if there is a limitation in the height along the road.

Calculations showed that the transportation height of a tower segment with a diameter of 4 m can be reduced about 20 cm by elastic deformation according to the invention.

The amount of deformation or the force applied to the tower segment is measured and tracked. Thus entering the area of plastic deformation is avoided.

The elastic deformation causes the segment to increase in width and to decrease in height, thus the limitations on the maximum height are overcome.

Preferably the tower segments do not contain reinforcements of the perimeter or flanges attached to the segments.

### BRIEF DESCRIPTION OF THE DRAWINGS

The invention is shown in more detail by help of a figure. The FIGURE shows only one preferred configuration and does not limit the scope of the invention.

### DETAILED DESCRIPTION OF INVENTION

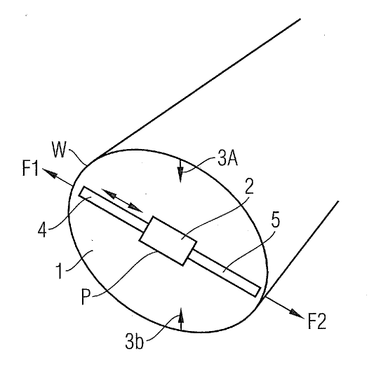

FIG. 1 shows a tower segment 1 with a circular cross section. The segment 1 is oriented horizontally, thus its longitudinal axis is horizontal.

Within the tower segment is a press P. The press is used to apply the force F1, F2 for the elastic deformation.

This press contains an actuator unit 2 and rams 4, 5, which apply the force in horizontal direction to the wall W of the tower segment 1. The resulting elastic deformation causes a first decrease in the height 3a and a second decrease in the height 3b of the horizontal oriented tower segment 1.

1.-14. (canceled)

15. A method of transporting a segment of wind turbine tower, comprising:
aligning a longitudinal axis of the segment horizontally during the transporting; and
deforming the segment in a cross section during the transporting by a force acting on a wall of the segment.

16. The method according to claim 15, wherein the segment is deformed in the cross-section in a substantially horizontally longish shape such that a height decreases and a width increases.

17. The method according to claim 16, wherein the deforming of the segment is in an elastic range of the segment and the deforming of the segment is reversible.

18. The method according to claim 17, wherein gravitational force is used as acting force.

19. The method according to claim 15, wherein the force for the deforming is applied to the wall of the segment in a horizontal and/or vertical direction.

20. The method according to claim 17, wherein the force for the elastic deformation varies.

21. The method according to claim 17, wherein the force is applied permanently during the transporting.

22. The method according to claim 15, wherein the force is applied by a press.

23. An arrangement for transporting a segment of wind turbine towers, comprising:
a tower segment, the longitudinal axis of the segment being substantially aligned horizontally during a transport; and
a deforming device which is constructed and arranged such that a force is applied by the deforming device to a wall of the tower segment in order to deform a cross section of the tower segment during the transport.

24. The arrangement according to claim 23, wherein the deforming device is a hydraulic press or a pneumatic press or an electrical press.

25. The arrangement according to claim 24, wherein the deforming device is detachably fixed to an outer side of the wall.

26. The arrangement according to claim 24, wherein the press is arranged inside the tower segment to allow the force to act on the wall from inside the tower segment.

27. The arrangement according to claim 24, wherein the press is arranged outside the tower segment to allow the force to act on the wall from outside the tower segment.

28. The arrangement according to claim 24, wherein the press is a set of presses including at least two presses.

29. The arrangement according to claim 24, wherein the set of presses is arranged diametrically in view of the cross section of the tower segment.

30. The arrangement according to claim 24, wherein a first press and a second press are arranged in the same cross section of the segment with an angle in between in view of a center point of the tower segment.
